(19) United States
(12) Patent Application Publication
(10) Pub. No.: US 2022/0171997 A1
(43) Pub. Date: Jun. 2, 2022

(54) SYSTEM AND METHOD FOR AUTOMATED GENERATION OF OPTIMUM THRESHOLDS FOR POST PROCESSING OF MACHINE LEARNING MODELS IN CASE OF IMBALANCED CLASSIFICATION

(71) Applicant: Aviso, Inc., Redwood City, CA (US)

(72) Inventors: Joy MUSTAFI, Hyderabad (IN); Sayan Deb KUNDU, Kolkata (IN); Trevor RODRIGUES, Scottsdale, AZ (US)

(73) Assignee: Aviso, Inc., Redwood City, CA (US)

(21) Appl. No.: 17/110,085

(22) Filed: Dec. 2, 2020

(51) Int. Cl. G06K 9/62; G06N 20/00

(52) U.S. Cl. CPC G06K 9/6257; G06N 20/00; G06K 9/6265

(57) ABSTRACT

A system (100) and method for automated generation of optimum thresholds for post processing of machine learning models in case of imbalanced classification. The system (100) includes a server computer (104) and an user device (112). The server computer (104) includes a system processing unit (106), and an system server memory (120). The system processing unit (106) executes computer-readable instructions to automatically calculate the optimum thresholds for post processing of machine learning models. The machine learning model predicts a probability of class, and that probability is used to decide a crisp class label and for deciding a crisp class label a threshold is set, thus based on amount of variation of probability from threshold the crisp class label is decided. Thus optimum threshold needs to be generated to accurately decide a crisp class label in case of imbalance classification.

### FIELD OF INVENTION

The present invention relates to system and method for automated generation of optimum thresholds for post processing of machine learning models, and more specifically relates to system and method for automated generation of optimum thresholds for post processing of machine learning models in case of imbalanced classification.

Machine learning based classification models typically involve predicting a class label. However, many machine learning algorithms are capable of predicting a probability or scoring of class membership, and this must be interpreted before it can be mapped to a crisp class label. In general cases, this is achieved by using a threshold, such as 0.5, where all values equal or greater than the threshold are mapped to one class and all other values are mapped to another class.

For classification problems with a severe class imbalance, the default threshold of 0.5 can result in poor performance. As such, a simple and straightforward approach to improving the performance of a classifier that predicts probabilities on an imbalanced classification problem is to tune the threshold used to map probabilities to class labels.

### Patent Application Discloses.

The existing invention does not provide optimum threshold for machine learning model. The existing inventions are less comprehensive and flexible in generating optimum threshold. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a method for automated generation of optimum thresholds for post processing of machine learning models in case of imbalanced classification. A method of fitting machine learning model, the method having: A system processing unit of a server computer executes computer-readable instructions to retrieve raw data based on multiple classes. The system processing unit executes computer-readable instructions to create multi-class training dataset. The system processing unit executes computer-readable instructions to refine and quantify the multi-class training dataset. Further, the system processing unit executes computer-readable instructions to integrate all the multi-class training dataset and feed the multi-class training dataset into the machine learning model. The machine learning model gets properly fitted well with multi-class training dataset. A method of using the machine learning model to predict the probabilities, the method having: The system processing unit executes computer-readable instructions to feed the multi-class testing dataset into the machine learning model to predict the probabilities related to multiple classes. Thus machine learning scoring model predicts the probabilities related to multiple classes. A method for generating optimum thresholds for machine learning models, the method having: The system processing unit of the server computer executes computer-readable instruction to create multiple level of threshold within the solution space. The system processing unit of the server computer executes computer-readable instruction to convert all probabilities into crisp class labels for each level of threshold within the solution space. The system processing unit of the server computer executes computer-readable instruction that creates multiple-objective function to evaluate the crisp class. The system processing unit of the server computer executes computer-readable instruction uses the multiple-objective functions to evaluate the generated crisp class labels for each level of threshold within the solution space. Based on evaluation, the threshold that provides best prediction of crisp class labels is set as optimum thresholds for machine learning models. The machine learning model predicts a probability of class, and that probability is used to decide a crisp class label and for deciding a crisp class label a threshold is set, thus based on amount of variation of probability from threshold the crisp class label is decided. Thus optimum threshold needs to be generated to accurately decide a crisp class label in case of imbalance classification.

The main advantage of the present invention is that the present invention provides a statistically verifiable solution which has yielded positive results.

Yet another advantage of the present invention is that the present invention provides more comprehensive and flexible method to generate threshold for machine learning model.

Yet another advantage of the present invention is that the present invention performs holistically and computationally efficient calculation of optimal threshold in case of imbalanced classification problem optimization.

Yet another advantage of the present invention is that the present invention creates a multi-objective evaluation criterion for crisp classes for each threshold thus help in optimize calculation of threshold.

Yet another advantage of the present invention is that the present invention uses operations research based methodologies to solve the problem in an efficient way.

Further objectives, advantages, and features of the present invention will become apparent from the detailed description provided hereinbelow, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a flowchart of the method of the present invention.

FIG. 2 illustrates the architecture of the present invention.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; 13 and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

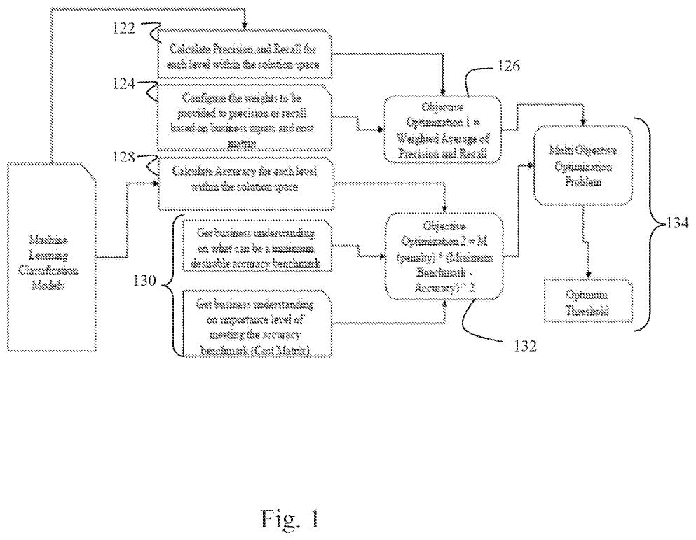

FIG. 1 illustrates an embodiment of method for generating optimum thresholds for machine learning models. In step (122), the system processing unit (106) of the server computer (104) executes computer-readable instruction to create multiple level of threshold within the solution space. The system processing unit (106) of the server computer (104) executes computer-readable instruction to convert all probabilities into crisp class labels for each level of threshold within the solution space. The system processing unit (106) of the server computer (104) executes computer-readable instruction to calculate precision, and recall from crisp class labels for each level of threshold within the solution space. In step (124), the system processing unit (106) of the server computer (104) executes computer-readable instruction to configure the weights to precision and recall based on business inputs and cost matrix. In step (126), based on the configured weight to precision and recall based, the first objective function is created. In step (128), the system processing unit (106) of the server computer (104) executes computer-readable instruction to calculate accuracy for each level of threshold within the solution space. In step (130), further, a minimum desirable accuracy benchmark is set, and penalty of not meeting the accuracy benchmark is also set. In step (132), by incorporating accuracy benchmark and penalty of not meeting the accuracy benchmark, the second objective function is created. In step (134), the system processing unit (106) of the server computer (104) executes computer-readable instruction uses the first objective function and the second objective function to evaluate the generated crisp class labels for each level of threshold within the solution space. Based on evaluation, the threshold that provides best prediction of crisp class labels is set as optimum thresholds for machine learning models.

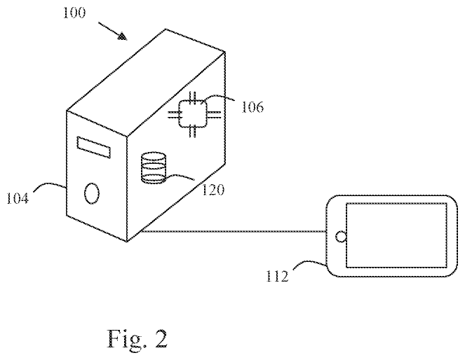

FIG. 2 illustrates a method for automated generation of optimum thresholds for post processing of machine learning models in case of imbalanced classification, is being executed with the help of a system (100). The system (100) includes a server computer (104) and a user device (112). The server computer (104) includes a system processing unit (106), and a system server memory (120). The user device (112) is connected to the server computer (104).

The present invention relates to a method for automated generation of optimum thresholds for post processing of machine learning models in case of imbalanced classification, the method having:

A method of fitting machine learning model, the method having
a system processing unit of a server computer, executes computer-readable instructions to retrieve raw data based on multiple classes;
the system processing unit executes computer-readable instructions to create multi-class training dataset;
the system processing unit executes computer-readable instructions to refine and quantify the multi-class training dataset;
further, the system processing unit executes computer-readable instructions to integrate all the multi-class training dataset and feed the multi-class training dataset into the machine learning model; and
the machine learning model gets properly fitted well with multi-class training dataset.

A method of using the machine learning model to predict the probabilities, the method having
the system processing unit executes computer-readable instructions to teed the multi-class testing dataset into the machine learning model to predict the probabilities related to multiple classes; and
thus machine learning scoring model predicts the probabilities related to multiple classes.
A method for generating optimum thresholds for machine learning models, the method having
the system processing unit of the server computer executes computer-readable instruction to create multiple level of threshold within the solution space;
the system processing unit of the server computer executes computer-readable instruction to convert all probabilities into crisp class labels for each level of threshold within the solution space;
the system processing unit of the server computer executes computer-readable instruction that creates multiple-objective function to evaluate the crisp class;
the system processing unit of the server computer executes computer-readable instruction uses the multiple-objective functions to evaluate the generated crisp class labels for each level of threshold within the solution space;

based on evaluation, the threshold that provides best prediction of crisp class labels is set as optimum thresholds for machine learning models.

In the preferred embodiment, the machine learning model predicts a probability of class, and that probability is used to decide a crisp class label and for deciding a crisp class label a threshold is set, thus based on amount of variation of probability from threshold the crisp class label is decided. Thus optimum threshold needs to be generated to accurately decide a crisp class label in case of imbalance classification.

In the preferred embodiment, the system processing unit executes Optimization Techniques not limited to goal programming or Operations Research methods for generating optimum thresholds for machine learning models.

in the preferred embodiment, the method of creating a multiple objective function which is convex and that provided optimum threshold for machine learning model, the method having:

the system processing unit of the server computer executes computer-readable instruction to calculate precision, and recall from crisp class labels for each level of threshold within the solution space;

the system processing unit of the server computer executes computer-readable instruction to configure the weights to be provided to precision and recall based on business inputs and cost matrix;

the system processing unit of the server computer executes computer-readable instruction to calculate accuracy for each level of threshold within the solution space;

further, a minimum desirable accuracy benchmark is set, and penalty of not meeting the accuracy benchmark is also set; and

by incorporating above parameter, the multiple objective function is created.

In the preferred embodiment, the precision measures the proportion of true positives from the total prediction. Herein, recall measures the proportion of true positives that are correctly identified.

in an embodiment, the present invention relates to a method for automated generation of optimum thresholds for post processing of machine learning models in case of imbalanced classification, the method having:

A method of fitting machine learning model, the method having
one or more system processing units of a server computer, execute computer-readable instructions to retrieve raw data based on multiple classes;
the one or more system processing units execute computer-readable instructions to create multi-class training dataset;
the one or more system processing units execute computer-readable instructions to refine and quantify the multi-class training dataset;
further, the one or more system processing units execute computer-readable instructions to integrate all the multi-class training dataset and feed the multi-class training dataset into the machine learning model; and
the machine learning model gets properly fitted well with multi-class training dataset.

A method of using the machine learning model to predict the probabilities, the method having
the one or more system processing units execute computer-readable instructions to feed the multi-class testing dataset into the machine learning model to predict the probabilities related to multiple classes; and
thus machine learning scoring model predicts the probabilities related to multiple classes.
A method for generating optimum thresholds for machine learning models, the method having
the one or more system processing units of the server computer execute computer-readable instruction to create multiple level of threshold within the solution space;
the one or more system processing units of the server computer execute computer-readable instruction to convert all probabilities into crisp class labels for each level of threshold within the solution space;
the one or more system processing units of the server computer execute computer-readable instruction that creates multiple-objective function to evaluate the crisp class;
the one or more system processing units of the server computer execute computer-readable instruction uses the multiple-objective functions to evaluate the generated crisp class labels for each level of threshold within the solution space;
based on evaluation, the threshold that provides best prediction of crisp class labels is set as optimum thresholds for machine learning models.

In the preferred embodiment, the machine learning model predicts a probability of class, and that probability is used to decide a crisp class label and for deciding a crisp class label a threshold is set, thus based on amount of variation of probability from threshold the crisp class label is decided. Thus optimum threshold needs to be generated to accurately decide a crisp class label in case of imbalance classification.

In the preferred embodiment, the one or more system processing units execute Optimization Techniques not limited to goal programming or Operations Research methods for generating optimum thresholds for machine learning models.

In the preferred embodiment, the method of creating a multiple objective function which is convex and that provided optimum threshold for machine learning model, the method having:

the one or more system processing units of the server computer execute computer-readable instruction to calculate precision, and recall from crisp class labels for each level of threshold within the solution space;

the one or more system processing units of the server computer execute computer-readable instruction to configure the weights to be provided to precision and recall based on business inputs and cost matrix;

the one or more system processing units of the server computer execute computer-readable instruction to calculate accuracy for each level of threshold within the solution space;

further, a minimum desirable accuracy benchmark is set, and penalty of not meeting the accuracy benchmark is also set; and

by incorporating above parameter, the multiple objective function is created.

In the preferred embodiment, the precision measures the proportion of true positives from the total prediction. Herein, recall measures the proportion of true positives that are correctly identified.

In an embodiment, method for automated generation of optimum thresholds for post processing of machine learning models in case of imbalanced classification is executed with the help of a system. The system includes a server computer and an user device. The server computer includes a system processing unit, and an system server memory. The system processing unit executes computer-readable instructions to automatically calculate the optimum thresholds for post processing of machine learning models. The system server memory stores computer-readable instructions, and the trained machine learning scoring model. The user device is connected to the server computer. A user receives optimum thresholds for post processing of machine learning models, on the user device. In an embodiment, the user device includes, but not limited to, a desktop, laptop, a tab, a smartphone.

In an embodiment, method for automated generation of optimum thresholds for post processing of machine learning models in case of imbalanced classification is executed with the help of a system. The system includes a server computer and one or more user devices. The server computer includes one or more system processing units, and an system server memory. The one or more system processing units execute computer-readable instructions to automatically calculate the optimum thresholds for post processing of machine learning models. The system server memory stores computer-readable instructions, and the trained machine learning scoring model. The one or more user devices are connected to the server computer. A user receives optimum thresholds for post processing of machine learning models, on the one or more user devices. In an embodiment, the one or more user devices include, but not limited to, a desktop, laptop, a tab, a smartphone.

In an embodiment, present invention relates to a method for automated generation of optimum thresholds for post processing of machine learning models in case of imbalanced classification. The method includes:

A method of fitting machine learning model, the method having

a system processing unit of a server computer, executes computer-readable instructions to retrieve raw data based on multiple classes;

the system processing unit executes computer-readable instructions to create multi-class training dataset;

the system processing unit executes computer-readable instructions to refine and quantify the multi-class training dataset;

further, the system processing unit executes computer-readable instructions to integrate all the multi-class training dataset and feed the multi-class training dataset into the machine learning model;

the machine learning model gets properly fitted well with multi-class training dataset.

A method of using the machine learning model to predict the probabilities, the method haying

the system processing unit executes computer-readable instructions to feed the multi-class testing dataset into the machine learning model to predict the probabilities related to multiple classes;

thus machine learning scoring model predicts the probabilities related to multiple classes.

A method for generating optimum thresholds for machine learning models, the method having

the system processing unit of the server computer executes computer-readable instruction to create multiple level of threshold within the solution space;

the system processing unit of the server computer executes computer-readable instruction to convert all probabilities into crisp class labels for each level of threshold within the solution space;

the system processing unit of the server computer executes computer-readable instruction to calculate precision, and recall from crisp class labels for each level of threshold within the solution space;

the system processing unit of the server computer executes computer-readable instruction to configure the weights to precision and recall based on business inputs and cost matrix;

based on the configured weight to precision and recall based, the first objective function is created;

the system processing unit of the server computer executes computer-readable instruction to calculate accuracy for each level of threshold within the solution space;

further, a minimum desirable accuracy benchmark is set, and penalty of not meeting the accuracy benchmark is also set;

by incorporating accuracy benchmark and penalty of not meeting the accuracy benchmark, the second objective function is created: and

the system processing unit of the server computer executes computer-readable instruction uses the first objective function and the second objective function to evaluate the generated crisp class labels for each level of threshold within the solution space.

based on evaluation, the threshold that provides best prediction of crisp class labels is set as optimum thresholds for machine learning models.

In an embodiment, present invention relates to a method for automated generation of optimum thresholds for post processing of machine learning models in case of imbalanced classification. The method includes:

A method of fitting machine learning model, the method having

one or more system processing units of a server computer, execute computer-readable instructions to retrieve raw data based on multiple classes;

the one or more system processing units execute computer-readable instructions to create multi-class training dataset;

the one or more system processing units execute computer-readable instructions to refine and quantify the multi-class training dataset;

further, the one or more system processing units execute computer-readable instructions to integrate all the multi-class training dataset and feed the multi-class training dataset into the machine learning model;

the machine learning model gets properly fitted well with multi-class training data set.

A method of using the machine learning model to predict the probabilities, the method having

the one or more system processing units execute computer-readable instructions to feed the multi-class testing dataset into the machine learning model to predict the probabilities related to multiple classes;

thus machine learning scoring model predicts the probabilities related to multiple classes.

A method for generating optimum thresholds for machine learning models, the method having

the one or more system processing units of the server computer execute computer-readable instruction to create multiple level of threshold within the solution space;

the one or more system processing units of the server computer execute computer-readable instruction to convert all probabilities into crisp class labels for each level of threshold within the solution space;

the one or more system processing units of the server computer execute computer-readable instruction to calculate precision, and recall from crisp class labels for each level of threshold within the solution space;

the one or more system processing units of the server computer execute computer-readable instruction to configure the weights to precision and recall based on business inputs and cost matrix;

based on the configured weight to precision and recall based, the first objective function is created;

the one or more system processing units of the server computer execute computer-readable instruction to calculate accuracy for each level of threshold within the solution space;

further, a minimum desirable accuracy benchmark is set, and penalty of not meeting the accuracy benchmark is also set;

by incorporating accuracy benchmark and penalty of not meeting the accuracy benchmark, the second objective function is created; and

the one or more system processing units of the server computer execute computer-readable instruction uses the first objective function and the second objective function to evaluate the generated crisp class labels for each level of threshold within the solution space.

based on evaluation, the threshold that provides best prediction of crisp class labels is set as optimum thresholds for machine learning models.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/we claim

1. A method for automated generation of optimum thresholds for post processing of machine learning models in case of imbalanced classification, the method comprising:
a method of fitting machine learning model, the method having
an at least one system processing unit (106) of a server computer (104), executes computer-readable instructions to retrieve raw data based on multiple classes_{;}
the at least one system processing unit (106) executes computer-readable instructions to create multi-class training dataset, and
the at least one system processing unit (106) executes computer-readable instructions to refine and quantify the multi-class training dataset;
further, the at least one system processing unit (106) executes computer-readable instructions to integrate all the multi-class training dataset and feed the multi-class training dataset into the machine learning model,
the machine learning model gets properly fitted well with multi-class training dataset;
a method of using the machine learning model to predict the probabilities, the method having
the at least one system processing unit (106) executes computer-readable instructions to feed the multi-class testing dataset into the machine learning model to predict the probabilities related to multiple classes,
thus machine learning scoring model predicts the probabilities related to multiple classes; and
a method for generating optimum thresholds for machine learning models, the method having
the at least one system processing unit (106) of the server computer (104) executes computer-readable instruction to create multiple level of threshold within the solution space,
the at least one system processing unit (106) of the server computer(104) executes computer-readable instruction to convert all probabilities into crisp class labels for each level of threshold within the solution space,
the at least one system processing unit (106) of the server computer (104) executes computer-readable instruction that creates multiple-objective function to evaluate the crisp class,
the at least one system processing unit (106) of the server computer (104) executes computer-readable instruction uses the multiple-objective functions to evaluate the generated crisp class labels for each level of threshold within the solution space, based on evaluation, the threshold that provides best prediction of crisp class labels is set as optimum thresholds for machine learning models.

2. The method as claimed in claim 1, wherein, the threshold the machine learning model predicts a probability of class, and that probability is used to decide a crisp class label and for deciding a crisp class label a threshold is set, thus based on amount of variation of probability from threshold the crisp class label is decided, thus optimum threshold needs to be generated to accurately decide a crisp class label in case of imbalance classification.

3. The method as claimed in claim 1, wherein, the at least one system processing unit (106) executes Optimization Techniques not limited to goal programming or Operations Research methods for generating optimum thresholds for machine learning models.

4. The method as claimed in claim 1, wherein, the method of creating a multiple objective function which is convex and that provided optimum threshold for machine learning model, the method comprising:
the at least one system processing unit (106) of the server computer (104) executes computer-readable instruction to calculate precision, and recall from crisp class labels for each level of threshold within the solution space;
the at least one system processing unit (106) of the server computer(104) executes computer-readable instruction to configure the weights to be provided to precision and recall based on business inputs and cost matrix;
the at least one system processing unit (106) of the server computer (104) executes computer-readable instruction to calculate accuracy for each level of threshold within the solution space;
further, a minimum desirable accuracy benchmark is set, and penalty of not meeting the accuracy benchmark is also set; and
by incorporating above parameter, the multiple objective function is created;

5. The method as claimed in claim 4, wherein, precision measures the proportion of true positives from the total prediction, wherein, recall measures the proportion of true positives that are correctly identified.

6. The method as claimed in claim 1, method for automated generation of optimum thresholds for post processing of machine learning models in case of imbalanced classification, is being executed with the help of a system (100), the system (100) comprising:
the server computer (104), the server computer (104) having
the at least one system processing unit (106), the at least one system processing unit (106) executes computer-readable instructions to automatically calculate the optimum thresholds for post processing of machine learning models,
the system server memory (120), the system server memory (120) stores computer-readable instructions, and the trained machine learning scoring model, and
the at least one user device (112), the at least one user device (112) is connected to the server computer (104), a use receives optimum thresholds for post processing of machine learning models, on the at least one user device (116);

7. The at least one user device (112) as claimed in claim 6, the at least one user device (112) is selected from a desktop, laptop, a tab, a smartphone.

8. A method for automated generation of optimum thresholds for post processing of machine learning models in case of imbalanced classification, the method comprising:
a method of fitting machine learning model, the method having
an at least one system processing unit (106) of a server computer (104), executes computer-readable instructions to retrieve raw data based on multiple classes,
the at least one system processing unit (106) executes computer-readable instructions to create multi-class training dataset, and
the at least one system processing unit (106) executes computer-readable instructions to refine and quantify the multi-class training dataset;
further, the at least one system processing unit (106) executes computer-readable instructions to integrate all the multi-class training dataset and feed the multi-class training dataset into the machine learning model,
the machine learning model gets properly fitted well with multi-class training dataset;
a method of using the machine learning model to predict the probabilities, the method having
the at least one system processing unit (106) executes computer-readable instructions to feed the multi-class testing dataset into the machine learning model to predict the probabilities related to multiple classes;
thus machine learning scoring model predicts the probabilities related to multiple classes; and
a method for generating optimum thresholds for machine learning models, the method having
the at least one system processing unit (106) of the server computer (104) executes computer-readable instruction to create multiple level of threshold within the solution space,
the at least one system processing unit (106) of the server computer(104) executes computer-readable instruction to convert all probabilities into crisp class labels for each level of threshold within the solution space,
the at least one system processing unit (106) of the server computer (104) executes computer-readable instruction to calculate precision, and recall from crisp class labels for each level of threshold within the solution space,
the at least one system processing unit (106) of the server computer (104) executes computer-readable instruction to configure the weights to precision and recall based on business inputs and cost matrix,
based on the configured weight to precision and recall based, the first objective function is created,
the at least one system processing unit (106) of the server computer (104) executes computer-readable instruction to calculate accuracy for each level of threshold within the solution space,
further, a minimum desirable accuracy benchmark is set, and penalty of not meeting the accuracy benchmark is also set,
by incorporating accuracy benchmark and penalty of not meeting the accuracy benchmark the second objective function is created,
the at least one system processing unit (106) of the server computer (104) executes computer-readable instruction uses the first objective function and the second objective function to evaluate the generated crisp class labels for each level of threshold within the solution space, and
based on evaluation, the threshold that provides best prediction of crisp class labels set as optimum thresholds for machine learning models.
